(19) United States
(12) Patent Application Publication
(10) Pub. No.: US 2008/0043736 A1
(43) Pub. Date: Feb. 21, 2008

(54) Data Transfer System and Method

(75) Inventor: David Stanley, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: DRIVECAM, INC., San Diego, CA (US)

(21) Appl. No.: 11/465,765

(22) Filed: Aug. 18, 2006

(51) Int. Cl. H04L 12/56

(52) U.S. Cl. 370/392; 370/401

(57) ABSTRACT

A data transfer system and method allows data files to be transmitted from a user device through a private network and a public network to a destination server without requiring write permission at an intermediate server of the private network. A configurable segment of data is read from a file to be transmitted. A network message having a header and a data payload is then created and addressed to a destination server associated with a public network. The data segment is placed in the data payload of the network message. The network message is then sent over the private and public networks to the destination server. The process is repeated until the entire data file has been sent in a series of network messages to the destination server. The file is reconstructed at the destination server from the data segments in the series of received network messages.

### BACKGROUND

1. Field of the Invention

The present invention relates to data or file transfer from a local device to a remote server or other device over a network.

2. Related Art

In order to transfer data files over a network through an Internet connection or the like, an intermediate “write” permission is normally required if the files are temporarily stored in memory at an intermediate location. One example of this situation is in a fleet management system in which driving data is collected in vehicle mounted event detectors, and may then be transmitted over a private network to an evaluation server that is accessible via the Internet or some other public network.

Private company networks typically have firewalls or other protection between the private network and the Internet, to protect the private or company network against outsiders accessing its own private data resources. Accordingly, files transmitted through a company network from a source such as a vehicle mounted event detector, must be temporarily stored in memory somewhere on the company network before being transmitted to an outside evaluation server. The required intermediate write permission in these conventional systems are significantly problematic, especially when the company network policies forbid such write permissions.

Therefore, what is needed is a system and method that avoids the need for a temporary write permission which could potentially compromise network security.

### SUMMARY

According to one aspect of the present invention, a method for transmitting data files through a private network is provided. A configurable segment of data is first read from a file to be transmitted from a user device to a destination server through the private network. A network message addressed to the destination server is then created, the message comprising a header and a data payload, and the data segment from the file to be transmitted is then placed in the data payload of the network message. The network message is then sent over the private network and a public network to the destination server. The process is repeated until the entire data file has been sent in a series of network messages to the destination server. The data segments are extracted from the network messages and used to reconstruct the file at the destination server. If the file is small enough, it may be transmitted with only one message.

Using the method or methods as described above, the contents of a data file can be sent through a private network to a destination server without requiring temporary storage at an intermediate, private network server. The network messages may be sent to the destination server through the private network and a public network such as the Internet. The data segments may be attached to the network messages using Direct Internet Message Encapsulation (DIME) or similar specifications for sending and receiving Internet messages with additional file attachments. Internet messages are normally in Simple Object Access Protocol (SOAP) which specifies how to encode a Hypertext Transfer Protocol (HTTP) header and Extensible Markup Language (XML) file. Such messages are much more likely to be transmitted through security firewall servers of private networks without requiring “write” permissions on the web service directory. DIME allows the contents of a data file to be attached to network messages which can be transported through an Internet connection without being blocked by a firewall.

In one example, this method may be used for sending data collected by various event monitors in a security or monitoring system or the like. For example, fleet drivers may be monitored to collect data regarding risky driving behavior, accidents and other incidents. Various event capture devices in the vehicle will collect driving event data which must then be transmitted to an evaluation server for review and evaluation of the data. This is normally done by sending the event files from the vehicles to a local fleet server in a private network, and then across the Internet to the fleet monitoring system server. The method of this invention allows data files to be transmitted through the local fleet network without requiring write permissions on the network web service directory. This method will also be useful in many other applications where data is collected and subsequently must be transmitted through a private network to a remote server over the Internet.

According to another aspect of the present invention, a data transfer system is provided for transferring data files from a local device to a destination server through a private network. The local device has a processor configured to read successive configurable segments of data from a selected file until the entire file has been read. The processor has a message generator module configured to create a series of network messages addressed to the destination server, each network message having a header and a data payload, and to place each segment of data in the data payload of a respective network message. The processor further comprises a transmission module configured to send the series of network messages directly through the private network and a public network to the destination server. The destination server has a processor configured to receive the network messages and to reconstruct the selected file from the data segments extracted from the series of network messages.

In one embodiment, the network messages are DIME messages and are configured for direct transmission through the private network without requiring temporary storage at a private network server.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating an example of transmission of data through a private network and public network to a destination server according to an exemplary embodiment of the invention;

FIG. 2 is a block diagram illustrating a file transmitting system of the user device of FIG. 1;

FIG. 3 is a block diagram illustrating a file receiving system of the destination server of FIG. 1;

FIG. 4 is a flow diagram illustrating a data transfer method according to the exemplary embodiment;

FIG. 5 is a block diagram illustrating an exemplary wireless communication device that may be used in connection with the various embodiments described herein; and

FIG. 6 is a block diagram illustrating an exemplary computer system which may be used in connection with the various embodiments described herein.

### DETAILED DESCRIPTION

Certain embodiments as disclosed herein provide for transmission of various types of data files through a private network without requiring “Write” permissions on the private network server. For example, one method as disclosed herein allows for transmission of data files of driving event information collected by fleet vehicles through a private fleet network and a public network such as the Internet to a driving event evaluation server.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

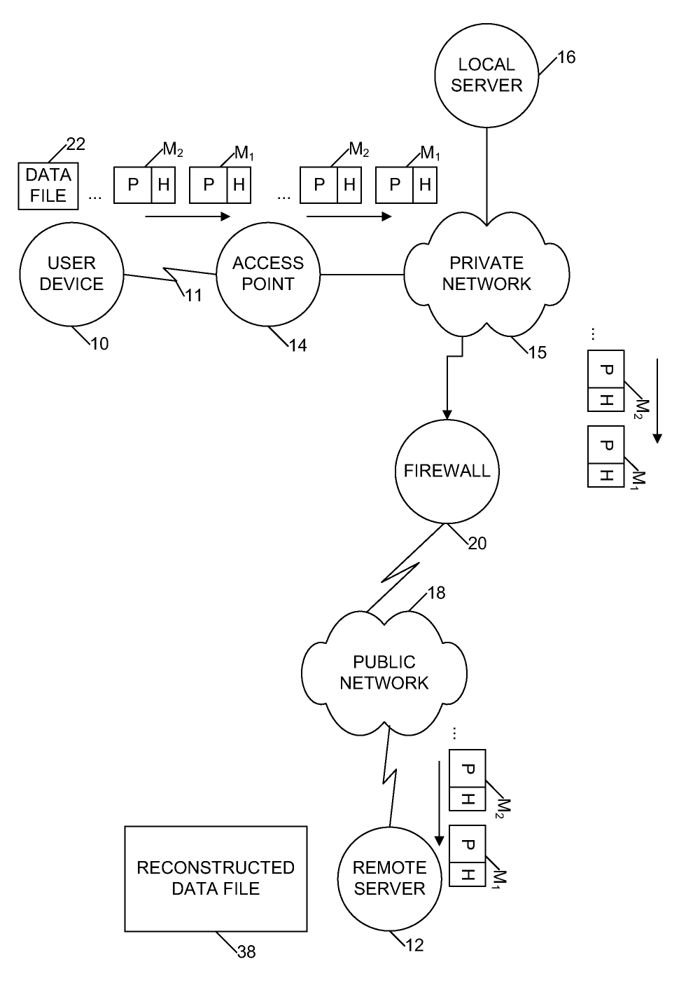

FIG. 1 illustrates the path of data transfer from a user device 10 to a remote or destination server 12 according to an exemplary embodiment of the invention. The user device 10 may comprise any type of computing device and associated data storage device, where data is collected in data files for subsequent transmission to a destination server 12 where the data is evaluated or used. One example of this is in a driving fleet, where it is desirable to collect driving event data for each fleet driver and vehicle for subsequent evaluation of potentially risky driving behavior or conditions. However, it will be understood that there are many other possible applications of the method and system of this invention in many different fields, such as security, inventory management, quality control in various industries, and the like. The method and system of this invention may be used in any situation where data files are to be transmitted to a remote server on a public network through a private network.

As illustrated in FIG. 1, the user device 10 communicates with an access point 14 of the private network 15 via link 11. The access point may be a wireless access point, a wired or wireless docking station, or the like, and the link 11 may be a wire link or a wireless link. Private network 15 is associated with a local or private server 16 and is linked to a public network 18 such as the Internet through a firewall 20.

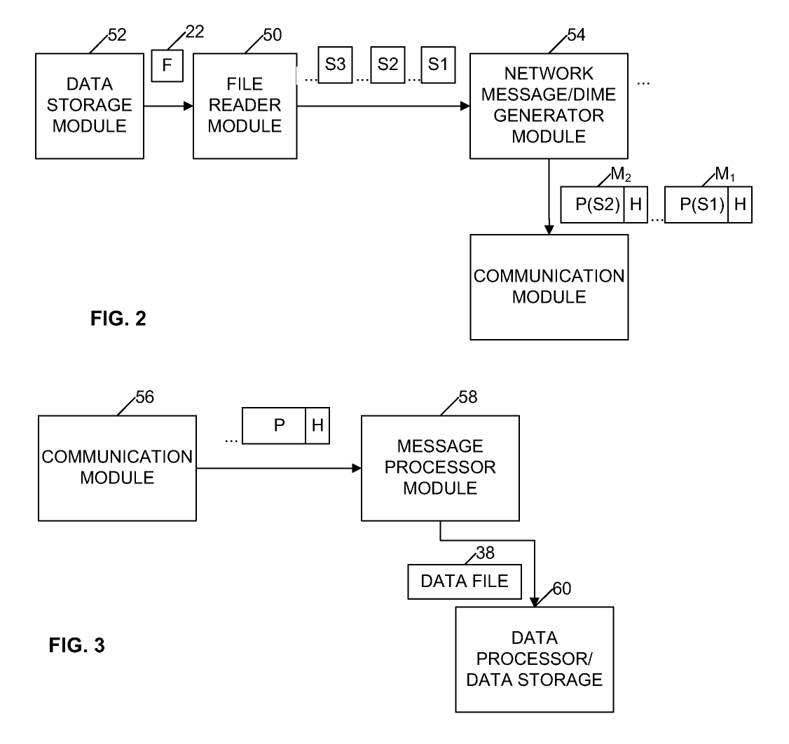

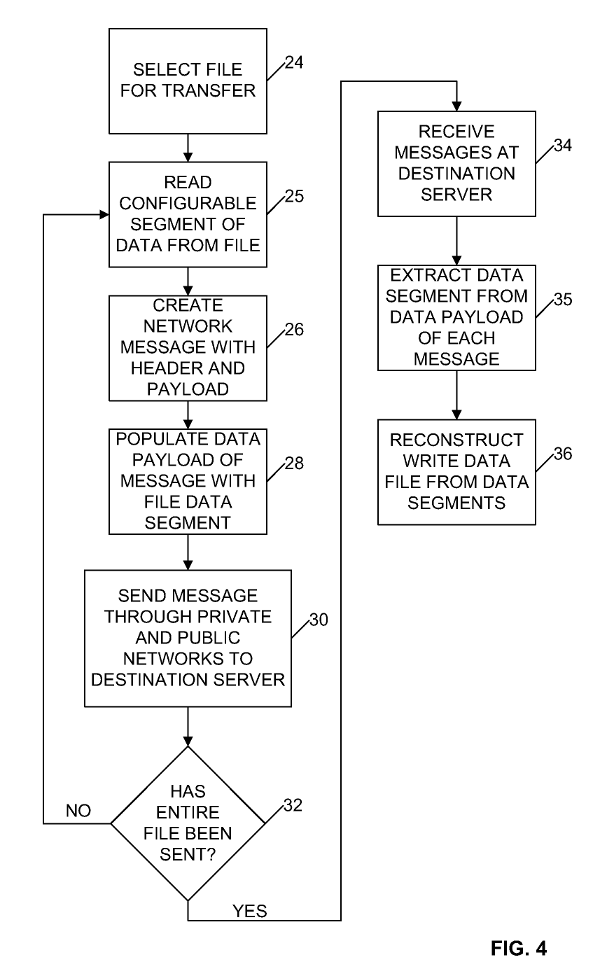

User device 10 includes a data transmission system as illustrated in FIG. 2 for converting data from stored data files into a format suitable for transmission through a private network without requiring an intermediate write permission at a private network server. The data transmission system comprises a file reader module 50 connected to data storage module 52 of the user device, a network message or Direct Internet Message Encapsulation (DIME) generator module 54, and a communication module 55 for transmitting messages created by module 54 through access point 14 to the private network 15. FIG. 3 illustrates the modules at the destination server for receiving and processing the messages delivered to the destination server from the user device through private and public networks 15, 18. The message receiving modules comprise a communication module 56 for receiving messages from the public network 18, and a message processor module 58 for processing the messages, as described in more detail below in connection with FIG. 4. Message processor module 58 is connected to a data processor or storage module 60 of the destination server for processing or storing data files created by module 58.

FIG. 4 is a flow diagram illustrating the steps of a method according to an exemplary embodiment of the invention for transmitting a data file through the private and public networks 15, 18 of FIG. 1 to the destination server 12 without requiring intermediate write permissions at the private network. The same basic method may be used for various transmission paths which involve one or more private networks.

Referring to FIGS. 1, 2 and 4, a data file 22 is first selected by the user device 10 for transmission to the remote or destination server 12 (step 24). The user device includes programmed instructions for configuring the data in a file 22 selected from data storage unit 52 for transmission to the destination server. In a first step 25, a configurable segment S1 of data is read from the file by the file reader module 50. A network message M₁ addressed to the destination server is then created (26) by network message generator module 54. The network message may be any type of Internet message similar to an electronic mail message which can be transmitted across any number of local or private servers 16 (also known as Onsite Client Servers or OCS). Network message M₁ may be created with a communications specification which defines a format for attaching files to messages sent between application programs over the Internet, such as Direct Internet Message Encapsulation (DIME) or the like. DIME messages are created by a DIME generator and consumed by a DIME parser. Message M₁ has a header H and a data payload P, and the payload is populated with the data segment S1 previously read from the data file (step 28).

The message M₁ is then sent by communication module 55 through the private network 15 and public network 18 to the communication module 56 at destination server 12 (step 30), as indicated in FIG. 1. Communication modules 55 and 56 may be wireless or wire communication modules. If more data remains in the file 22 (step 32), the next configurable segment S2 of data is read by file reader module 50 at step 25, a second network message M₂ is created by network message or DIME generator module 54 (step 26), and the data payload of message M₂ is populated with the data segment (step 28), before sending message M₂ through networks 15 and 18 to the destination server 12 (step 30). These steps are repeated until the entire file has been read and messages M₁, M₂ . . . Mₙ have been sent to the destination or remote server, where n is the total number of configurable segments of data in the file.

Although steps 24 to 32 are shown as a sequence in FIG. 4, it will be understood that the creation of a new network message may commence as soon as a previous network message has been created (i.e. at the completion of step 28), in parallel with transmission of the previously created message at step 30.

The messages M₁, M₂ . . . Mₙ are received at the destination server (step 34), and the data segment is extracted from each message by the processor module 58 (step 35). The original data file is then reconstructed from the extracted data segments (step 36), and the reconstructed data file is stored or further processed as desired, according to programmed instructions at the destination server.

This method allows file transfer to be executed across any number of private network OCSs or local servers without reconstructing or writing the file until the destination is reached. This will considerably simplify file transfer since there will be no need to have any intermediate write permissions at the OCSs. Successive segments of each data file are simply populated in the data payload of a series of network messages such as DIME messages which utilize the World Wide Web (www) Hypertext Transfer Protocol (HTTP) in the header. Since HTTP requests are usually allowed through firewalls, the network messages can be transmitted through any number of private networks without needing intermediate write permissions at the private network or OC servers. The file data is not distinguished from the rest of the data in the network message transmitted through the private network, and does not have to be reconstructed and written to any intermediate server of a private network, as is the normal rule for conventional data files. The remote server is configured to receive the series of messages associated with each file, and extract the sequence of data segments from the payloads of the messages before reconstructing/writing the file on the remote server.

As noted above, one situation where the method and system of this invention may be used is for evaluating driving data for an organization having a fleet of motor vehicles, although it is applicable to many different data collection scenarios where the collected data has to be transmitted to a remote server through one or more private networks. In the specific instance mentioned above, each vehicle in the fleet will have an on-board computer unit or user device linked to one or more driving event data collection devices, such as cameras and various sensors. Data from these devices is collected in a data storage area of the computer unit for subsequent transmission to the remote evaluation server for further analysis. The method and system of this invention allows such data to be transmitted in separate segments as the payload of a series of network messages, avoiding the need for write permissions on a private network such as the network of the organization having the fleet vehicles.

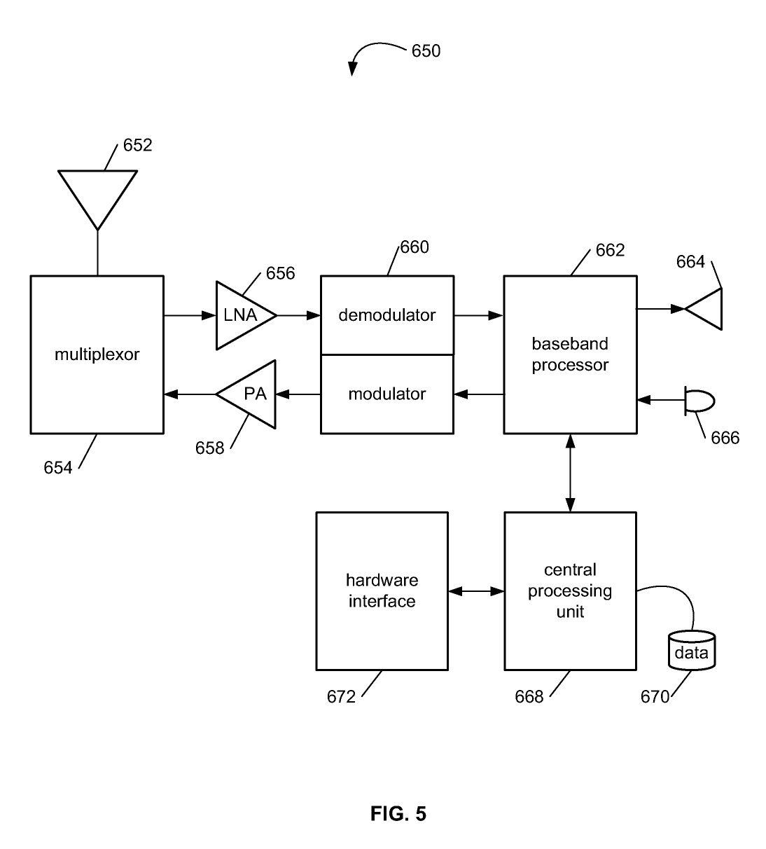

The user device 10 of FIG. 1 will include any suitable computing device and data storage, as well as the communication device 55 for transmitting and receiving data over link 11 to a network 15. As noted above, link 11 may be a wired or wireless link, and the communication device may provide for wired, wireless or both wired and wireless communications. FIG. 5 illustrates an exemplary wireless communication device which may be used to transmit network messages M₁, M₂ . . . Mₙ from user device 10. A similar wireless communication device may be used as module 56 at the remote server 12 for receiving the network messages and providing them to the server for further processing in order to reconstruct the data file.

As noted above, FIG. 5 is a block diagram illustrating an exemplary wireless communication device 650 that may be used in connection with the various embodiments described herein. For example, the wireless communication device 650 may be used in conjunction with user device 10 to transmit the network messages, and a wireless communication device 650 may also be used in conjunction with the remote or destination server 12 for receiving the network messages. However, other wireless communication devices and/or architectures may also be used, as will be clear to those skilled in the art.

In the illustrated embodiment, wireless communication device 650 comprises an antenna 652, a multiplexor 654, a low noise amplifier (“LNA”) 656, a power amplifier (“PA”) 658, a modulation circuit 660, and a baseband processor 662. A central processing unit (“CPU”) 668 with a data storage area 670 is connected to the baseband processor 662, and a hardware interface 672 is connected to the baseband processor.

In the wireless communication device 650, radio frequency (“RF”) signals are transmitted and received by antenna 652. Multiplexor 654 acts as a switch, coupling antenna 652 between the transmit and receive signal paths. In the receive path, received RF signals are coupled from a multiplexor 654 to LNA 656. LNA 656 amplifies the received RF signal and couples the amplified signal to a demodulation portion of the modulation circuit 660.

Typically modulation circuit 660 will combine a demodulator and modulator in one integrated circuit (“IC”). The demodulator and modulator can also be separate components. The demodulator strips away the RF carrier signal leaving a base-band receive signal, which is sent from the demodulator output to the base-band processor 662.

The baseband processor 662 also codes digital signals for transmission and generates a baseband transmit signal that is routed to the modulator portion of modulation circuit 660. The modulator mixes the baseband transmit signal with an RF carrier signal generating an RF transmit signal that is routed to the power amplifier 658. The power amplifier 658 amplifies the RF transmit signal and routes it to the multiplexor 654 where the signal is switched to the antenna port for transmission by antenna 652.

The baseband processor 662 is also communicatively coupled with the central processing unit 668. The central processing unit 668 has access to data storage area 670. The central processing unit 668 is preferably configured to execute instructions (i.e., computer programs or software) that can be stored in the data storage area 670. Computer programs can also be received from the baseband processor 662 and stored in the data storage area 670 or executed upon receipt.

The central processing unit 668 is also preferably configured to receive notifications from the hardware interface 672 when new devices are detected by the hardware interface. Hardware interface 672 can be a combination electromechanical detector with controlling software that communicates with the CPU 668 and interacts with new devices. The hardware interface 672 may be a firewire port, a USB port, a Bluetooth or infrared wireless unit, or any of a variety of wired or wireless access mechanisms. Examples of hardware that may be linked with the device 650 include data storage devices, computing devices, headphones, microphones, and the like.

In this description, the term “computer readable medium” is used to refer to any media used to provide executable instructions (e.g., software and computer programs) to the wireless communication device 650 for execution by the central processing unit 668. Examples of these media include the data storage area 670, microphone 666 (via the baseband processor 662), antenna and multiplexor 654 (also via the baseband processor 662), and hardware interface 672. These computer readable mediums are means for providing executable code, programming instructions, and software to the wireless communication device 650. The executable code, programming instructions, and software, when executed by the central processing unit 668, preferably cause the central processing unit 668 to perform the inventive features and functions previously described herein. In other words, the central processing unit (CPU) at the user device is configured to create network messages and populate the data payload of such messages with successive configurable segments of data from a data file, while the CPU at the destination server is configured to extract the data segments from successive messages received at the destination server, reconstruct the original data file from the data segments, and write the data file to the server.

The central processing unit 668 is also preferably configured to receive notifications from the hardware interface 672 when new devices are detected by the hardware interface. Hardware interface 672 can be a combination electromechanical detector with controlling software that communicates with the CPU 668 and interacts with new devices. The hardware interface 672 may be a firewire port, a USB port, a Bluetooth or infrared wireless unit, or any of a variety of wired or wireless access mechanisms.

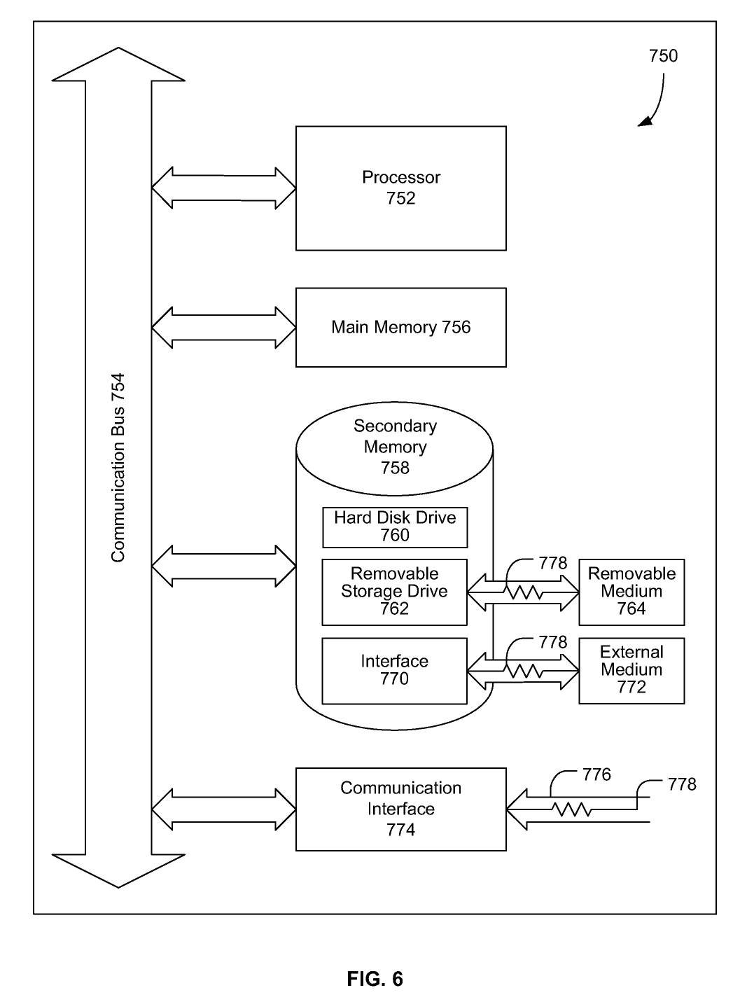

FIG. 6 is a block diagram illustrating an exemplary computer system 750 that may be used in connection with the various embodiments described herein. For example, the computer system 550 may be used in conjunction with the user device 10. A similar computer system may be used in conjunction with the remote server. A computer processor at the user device 10 will be programmed to carry out steps 24 to 32 of FIG. 4, while a computer processor at the remote server will be programmed to carry out steps 34 to 36 of FIG. 4. However, other computer systems and/or architectures may be used, as will be clear to those skilled in the art.

The computer system 750 preferably includes one or more processors, such as processor 752. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 752.

The processor 752 is preferably connected to a communication bus 754. The communication bus 754 may include a data channel for facilitating information transfer between storage and other peripheral components of the computer system 750. The communication bus 754 further may provide a set of signals used for communication with the processor 752, including a data bus, address bus, and control bus (not shown). The communication bus 754 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 750 preferably includes a main memory 756 and may also include a secondary memory 758. The main memory 756 provides storage of instructions and data for programs executing on the processor 752. The main memory 756 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 758 may optionally include a hard disk drive 760 and/or a removable storage drive 762, for example a floppy disk drive, a magnetic tape drive, a compact disc (“CD”) drive, a digital versatile disc (“DVD”) drive, etc. The removable storage drive 762 reads from and/or writes to a removable storage medium 764 in a well-known manner. Removable storage medium 764 may be, for example, a floppy disk, magnetic tape, CD, DVD, etc.

The removable storage medium 764 is preferably a computer readable medium having stored thereon computer executable code (i.e., software) and/or data. The computer software or data stored on the removable storage medium 764 is read into the computer system 750 as electrical communication signals 778.

In alternative embodiments, secondary memory 758 may include other similar means for allowing computer programs or other data or instructions to be loaded into the computer system 750. Such means may include, for example, an external storage medium 772 and an interface 770. Examples of external storage medium 772 may include an external hard disk drive or an external optical drive, or and external magneto-optical drive.

Other examples of secondary memory 758 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 772 and interfaces 770, which allow software and data to be transferred from the removable storage unit 772 to the computer system 750.

Computer system 750 may also include a communication interface 774. The communication interface 774 allows software and data to be transferred between computer system 750 and external devices (e.g. printers), networks, or information sources. For example, computer software or executable code may be transferred to computer system 750 from a network server via communication interface 774. Examples of communication interface 774 include a modem, a network interface card (“NIC”), a communications port, a PCMCIA slot and card, an infrared interface, and an IEEE 1394 fire-wire, just to name a few.

Communication interface 774 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 774 are generally in the form of electrical communication signals 778. These signals 778 are preferably provided to communication interface 774 via a communication channel 776. Communication channel 776 carries signals 778 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 756 and/or the secondary memory 758. Computer programs can also be received via communication interface 774 and stored in the main memory 756 and/or the secondary memory 758. Such computer programs, when executed, enable the computer system 750 to perform the various functions of the present invention as previously described.

In this description, the term “computer readable medium” is used to refer to any media used to provide computer executable code (e.g., software and computer programs) to the computer system 750. Examples of these media include main memory 756, secondary memory 758 (including hard disk drive 760, removable storage medium 764, and external storage medium 772), and any peripheral device communicatively coupled with communication interface 774 (including a network information server or other network device). These computer readable mediums are means for providing executable code, programming instructions, and software to the computer system 750.

In an embodiment that is implemented using software, the software may be stored on a computer readable medium and loaded into computer system 750 by way of removable storage drive 762, interface 770, or communication interface 774. In such an embodiment, the software is loaded into the computer system 750 in the form of electrical communication signals 778. The software, when executed by the processor 752, preferably causes the processor 752 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, and method steps described in connection with the above described figures and the embodiments disclosed herein can often be implemented as electronic hardware, computer software, or combinations of both. To clearly illustrate this interchangeability of hardware and software, various illustrative blocks, modules, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, or step is for ease of description. Specific functions or steps can be moved from one module, block or step to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method of transmitting data files through a private network without write permission, comprising the steps of:
reading at least a first configurable segment of data from a file to be transmitted from a user device to a destination server through a private network;
creating a first network message addressed to the destination server, the first network message comprising a header and a data payload;
placing the first data segment in the data payload of the first network message;
sending the first network message through the private network and a public network to the destination server without temporary storage at a local server of the private network; and
reconstructing at least a portion of the file from the first data segment in the first network message at the destination server.

2. The method as claimed in claim 1, further comprising reading a second configurable segment of data from the file;
creating a second network message addressed to the destination server, the second network message comprising a header and a data payload;
placing the second data segment in the data payload of the second network message; and
sending the second network message through the private network and a public network to the destination server without temporary storage at a local server of the private network;
reconstructing at least a portion of the file from the first and second data segments in the first and second network messages at the destination server.

3. The method as claimed in claim 1, wherein the data file contains a total of n data segments, and the steps of reading a data segment, creating a network message, and placing the data segment in the data payload of the network message are repeated until all of the data segments in the file have been placed in a series of n network messages which are sent through the private and public networks to the destination server, and the file is reconstructed at the destination server from the series of n data segments in the successive n network messages.

4. The method as claimed in claim 1, wherein each network message is a Direct Internet Message Encapsulation (“DIME”) message.

5. A method of transmitting data files through a private network without write permission, comprising the steps of:
reading a first configurable segment of data from a file to be transmitted from a user device to a destination server through a private network;
creating a first network message addressed to the destination server, the first network message comprising a header and a data payload;
placing the first data segment in the data payload of the first network message;
reading a second configurable segment of data from the file;
creating a second network message addressed to the destination server, the second network message comprising a header and a data payload;
placing the second data segment in the data payload of the second network message;
sending the first and second network messages through the private network and a public network to a destination server; and
reconstructing the file from the first and second data segments in the first and second network messages at the destination server.

6. The method as claimed in claim 5, wherein the data file contains a total of n data segments, and the steps of reading a data segment, creating a network message, and placing the data segment in the data payload of the network message are repeated until all of the data segments in the file have been placed in a series of n network messages which are sent through the private and public networks to the destination server, and the file is reconstructed at the destination server from the series of n data segments in the successive n network messages.

7. The method as claimed in claim 5, wherein the public network is the Internet.

8. The method as claimed in claim 5, wherein each network message is sent to the destination server without temporary data storage at a private network server.

9. The method as claimed in claim 5, wherein each network message is a Direct Internet Message Encapsulation (“DIME”) message.

10. The method as claimed in claim 5, wherein the step of sending the network message comprises transmitting the network message over a first link to an access point of the private network, and transmitting the network message directly from the access point through the private network and the public network to the destination server without temporary data storage at a private network server.

11. The method as claimed in claim 10, wherein the first link is a wire link.

12. The method as claimed in claim 10, wherein the first link is a wireless link.

13. A method for transmitting data files through a private network, comprising:
reading a configurable segment of data from a file to be transmitted from a user device to a destination server through the private network;
creating a network message addressed to the destination server, the message comprising a header and a data payload;
placing the data segment from the file to be transmitted in the data payload of the network message;
sending the network message through the private network and a public network to the destination server;
repeating the foregoing steps with successive segments of data from the data file until the entire data file has been sent in a series of network messages to the destination server; and
reconstructing the file at the destination server from the data segments in the series of network messages.

14. A data transfer system, comprising:
a local device having a series of stored files;
a private network having a series of access points;
the local device having a communication module for connection to at least one access point of the private network;
a public network communicating with the private network; and
at least one destination server communicatively coupled with the private network via the public network;
the local device having a file reader module configured to select a file from the stored files and read n successive configurable segments of data from the selected file until the entire file has been read, and a network message generator module linked to the file reader module and configured to create a series of n network messages addressed to the destination server, each network message having a header and a data payload, and to place each successive data segment in a respective network message in the series;
the communication module being linked to the network message generator module and configured to send the series of network messages through the private network and the public network to the destination server; and
the destination server having a receiver module configured to receive the network messages and a processor module configured to reconstruct the selected file from the successive data segments in the series of network messages.

15. The system as claimed in claim 14, further comprising an intermediate server associated with the intermediate network, the network messages being configured for direct transmission over the intermediate network without requiring temporary storage at the intermediate server.

16. The system as claimed in claim 14, wherein the public network is the Internet.

17. The system as claimed in claim 14, wherein the processor is configured to place each data segment in the data payload of a respective Direct Internet Message Encapsulation (“DIME”) message.

18. A data transfer system, comprising:
a local device having at least one file for selective transfer to a destination server through at least one private network;
the local device processor having reader means for reading successive configurable segments of data from the file until the entire file has been read, message generator means for creating network messages addressed to the destination server, the number of network messages corresponding to the number of configurable data segments in the file, each network message having a header and a data payload containing a respective data segment, and transmission means for transmitting each network message through said private network and a public network; and
a destination server associated with said public network for receiving each network message, the destination server having processor means for reconstructing the originally read data segment from the network message.

19. The system as claimed in claim 18, wherein the message generator means comprises means for placing successive data segments in the data payloads of respective successive network messages, and the transmission means comprising means for transmitting said network messages in series successively over said private and public networks to the destination server; and the processor means at the destination server comprising means for reconstructing the file from data segments in the series of network messages.

20. The system as claimed in claim 18, wherein the message generator means comprises means for generating a Direct Internet Message Encapsulation (DIME) message.
